(19) United States
(12) Patent Application Publication
(10) Pub. No.: US 2007/0247777 A1
(43) Pub. Date: Oct. 25, 2007

(54) Protective structure for electrostatic discharge

(75) Inventors: Der-Jang Sun, Taipei (TW); Ming-Yang Tsu, Taipei (TW)

Correspondence Address: REED SMITH LLP, Suite 1400, 3110 Fairview Park Drive, Falls Church, VA, 22042, US

(73) Assignee: Inventec Corporation

(21) Appl. No.: 11/409,073

(22) Filed: Apr. 24, 2006

(51) Int. Cl. H02H 1/00

(52) U.S. Cl. 361/212

(57) ABSTRACT

A protective structure for electrostatic discharge used to guide an electrostatic charge to a ground portion is provided, which comprises at least one press element and a masking piece, wherein an electrostatic charge near the press element is attracted by wrapping the press element with the masking piece, and then the attracted electrostatic charge is directed out of the press element, which greatly reduces the probability that the press element is interfered by the electrostatic charge and effectively shields the press element.

### BACKGROUND OF THE INVENTION

1. Field of Invention

The present invention relates to a protective structure for electrostatic discharge, and more particularly, to a protective structure for electrostatic discharge applied to a switch element that can be rapidly pressed.

1. Related Art

Electronic products are mostly in an electrostatic discharge (ESD) circumstance. ESD refers to a discharge phenomenon generated by ionization of gas near an object carrying charges by an electric field formed by the object. Electrostatic interference would damage an electronic element or a circuit. As for other electronic elements in danger of electrostatic release, though they may not be damaged and influenced immediately, there is a reduction in quality of the electronic products and the lifetime thereof is also shortened.

Electronic products mostly act as a rapid input interface by means of access keys for application software to exert effects thereby. However, in order to mount access keys on a keyboard, a plurality of holes is opened on the keyboard to place the access keys. The size of the holes is determined by considering that the size and the access key will not interfere with each other when pressing the access key or when the access key returns in situ after being pressed, therefore, in design, a slight gap will exist between the hole and the access key. However, due to the electrical properties of static electricity, when the access key is pressed, electrostatic charges on the human body itself or on other conductors are conducted to the access key and search for the closest conductive substance at any time to release electric power. When a substance carrying electrostatic charges gets close to the gap between the hole and the access key, the electrostatic charges on the substance will get into the keyboard through the gap and be conducted to the electronic elements within the keyboard, such that the electronic elements may be damaged by the static electricity on the substance and unable to operate normally.

Such a case, if occurring in a notebook computer, will result in an extremely severe problem. This is because the key of a notebook computer is typically very close to the motherboard in pursuit of lightness, thinness, and portability of the notebook computer, and a number of electronic elements are disposed on the motherboard, so any one of the electronic elements damaged by the electrostatic charges would render the notebook computer incapable of operating normally. Also, it is very difficult to identify an electronic element damaged by static electricity among the great deal of electronic elements on the motherboard, which also increases the difficulty in maintaining the notebook computer.

Referring to FIG. 1A, wherein a notebook computer 10 has at least one access key 11 and a housing 12, wherein a gap 13 exists between the access key 11 and the housing 12. When a user presses on the access key 11 with a finger, the electrostatic charges on the human body itself, on the access key 11, or those conducted through the gap 13 between the access key 11 and the housing 12 would be conducted into the interior of the notebook computer 10 through the access key 11 and the gap 13 which are both coated with a metallic material or made of metallic materials, such that the notebook computer 10 suffers from a problem of electrostatic discharge.

Referring to FIG. 2 and FIG. 3, the problem of electrostatic discharge suffered by the notebook computer 10 is solved through additionally disposing a masking piece 20a at the position of the access key 11. The outside electrostatic charges concentrate on the masking piece 20a for being attracted by the masking piece 20a with a low resistance. A ground portion 22a is disposed on the masking piece 20a corresponding to the gap 13, such that the electrostatic charges are conducted from the masking piece 20a to the ground portion 22a, and then are conducted from the ground portion 22a to the outside of the notebook computer 10, thus damage to the access key 11 from electrostatic charges can be avoided. However, the masking piece 20a is still unable to completely mask a signal output/input portion 111 of the access key 11, and the ground portion 22a may still meet free electrostatic charges, which render the electrostatic charges incapable of being conducted to a ground circuit of the notebook computer 10 and then released to the outside of the notebook computer 10, and thereby leading to malfunction and damage in the electronic elements.

Recently, operating electronic devices with press elements has been found everywhere in the market, however, there is no suitable resolution on the influence resulting from the electrostatic discharge of the press element. Therefore, it is a very appropriate resolution to avoid the occurrence of electrostatic discharge by preventing the accumulation of electrostatic charges.

### SUMMARY OF THE INVENTION

In the conventional art disclosed above, a structural design in a press element for preventing electrostatic discharge from damaging the element has not yet been considered completely. Such a structural design may enhance the functions of capturing the electrostatic charges and then concentrating them to successfully guide the electrostatic charges to the ground portion and may improve the shielding of the signal output/input portion in the press element from been interfered by electrostatic discharge, and therefore the present invention provides a protective structure suitable for electrostatic discharge of a press element.

The protective structure for electrostatic discharge disclosed according to the invention comprises a press element and a masking piece, wherein the press element is used to perform a preset control signal and has a signal output/input portion for being electrically connected to a motherboard, while the masking piece wraps the press element and has a plurality of protrusions corresponding to the signal output/input portion and a ground portion located at the bottom of the press element, and the ground portion may guide the electrostatic charges attracted by the masking piece and then guide them out of the electronic device.

A protective structure for electrostatic discharge disclosed according to the invention has a relatively large area to mask the signal output/input portion of the press element, wherein a good shielding effect for the signal output/input portion is provided to reduce the probability that electrostatic charges get close to the signal output/input portion, and furthermore, to enhance the ability of attracting the electrostatic charges such that besides that the electrostatic charges due to a direct pressing may be attracted, other free electrostatic charges may be captured too. Therefore, not only the ability of protecting from electrostatic discharge is enhanced, but also the probability that the signal output/input portion suffers from interference resulting from the electrostatic charges is reduced, and meanwhile the design cost caused by electrostatic discharge is reduced as well.

In order to make the above and other characteristics and advantages of the invention more comprehensible, two embodiments are given especially hereinafter and are illustrated in detail in with the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1A is a schematic view of appearance of a notebook computer;

FIG. 1B is a schematic sectional view of an access key of the notebook computer;

FIG. 2 is a top view of a masking piece of the conventional art;

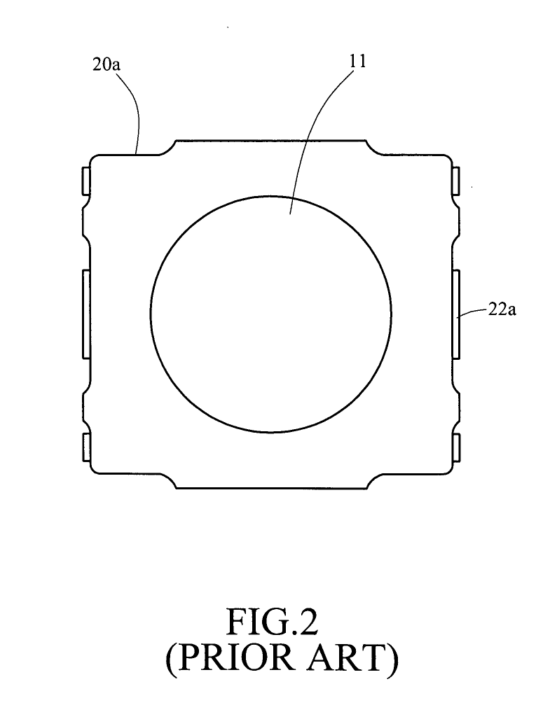

FIG. 3 is a bottom view of the masking piece of the conventional art;

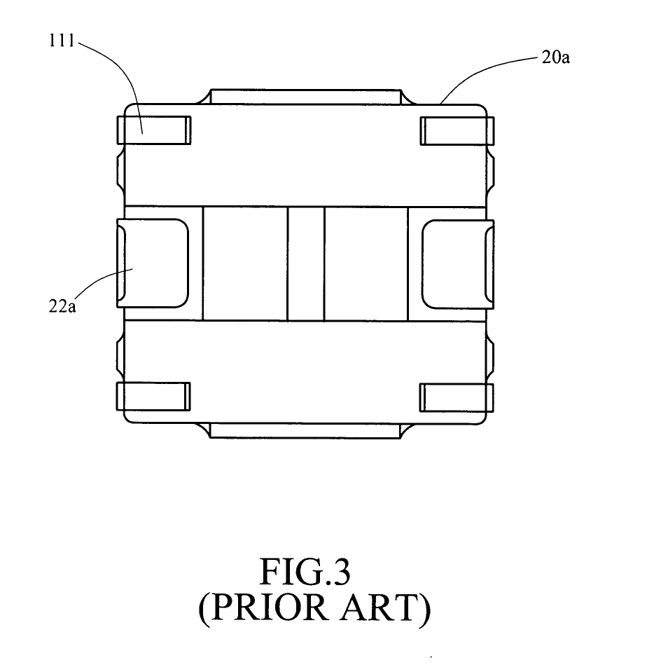

FIG. 4 is a schematic view of the structure of a masking piece in a first embodiment;

FIG. 5 is a schematic view of the structure of a masking piece in a second embodiment; and

FIG. 6 is another schematic view of structure of a masking piece in the second embodiment.

### DETAILED DESCRIPTION OF THE INVENTION

A protective structure for electrostatic discharge is provided according to the invention. The protective structure for electrostatic discharge referred to herein may be applied in a notebook computer. However, it is not limited only to being applied in a notebook computer, and devices performing a human-computer communication by pressing press elements such as Personal Digital Assistants (PDAs), Global Position Systems (GPSs), and Mobile Phones, may also apply the technology disclosed by the invention. In a detailed illustration of the invention below, a notebook computer will be taken as a preferred embodiment of the invention.

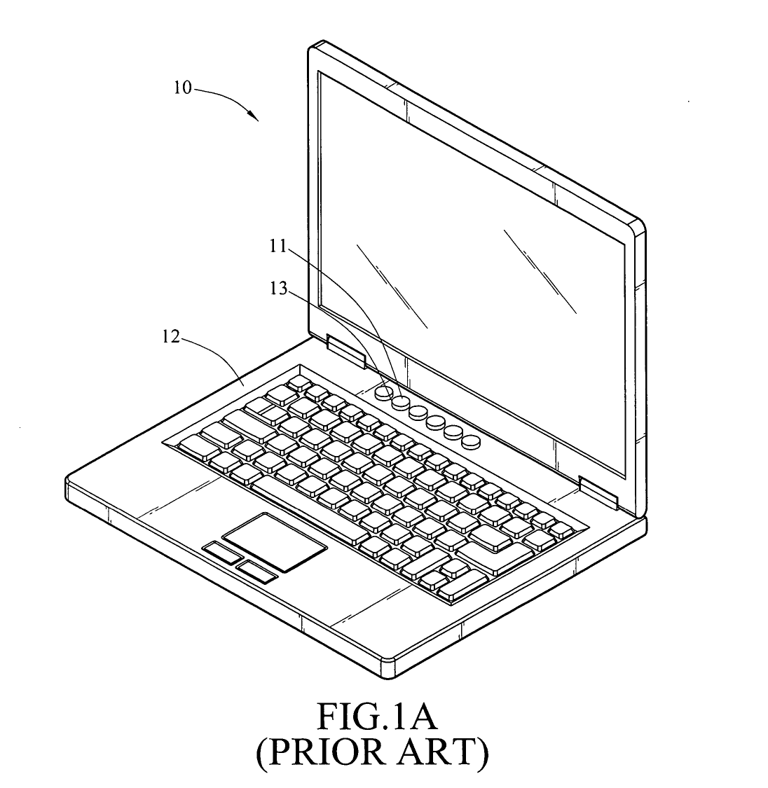

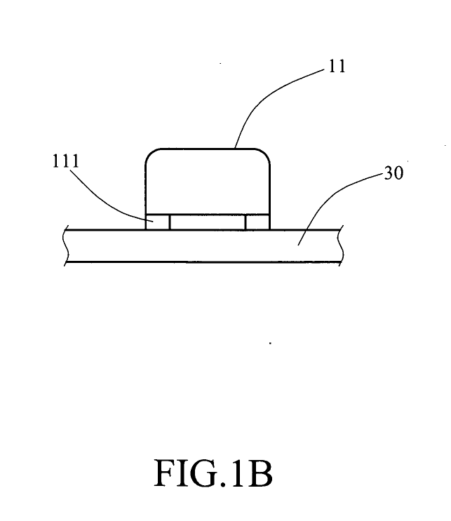

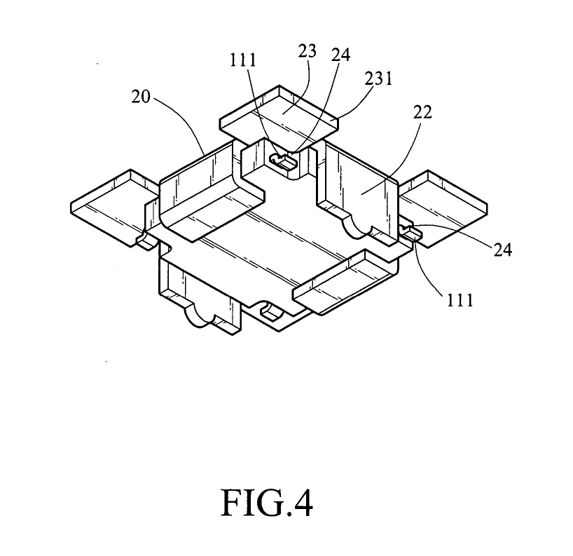

A first embodiment of the invention is shown as FIG. 1A, FIG. 1B, and FIG. 4. A notebook computer 10 in the embodiment shown in the drawings has at least one access key 11 comprising a signal output/input portion 111. A masking piece 20 made of conductive material may be disposed at the position of the access key 11, for wrapping the access key 11, which protects the access key 11 of the notebook computer 10 from being interfered and damaged by electrostatic discharge, such that the notebook computer 10 will not be rendered inoperative. The masking piece 20 comprises a ground portion 22 and a protrusion 23, wherein the ground portion 22 is located approximately at the bottom of the access key 11, and the protrusion 23 is disposed corresponding to the position of the signal output/input portion 111 and having a level edge 231. A hole 210 in which the access key 11 is located to be wrapped is opened on the masking piece 20, while the protrusion 23 is disposed extendedly along the edge of the masking piece 20. A difference in height exists between the bottoms of the protrusion 23 and the masking piece 20 so as to form a masking area 24 located above the signal output/input portion 111. The top surfaces of the masking piece 20 and the protrusion 23 are coplanar, while the ground portion 22 is disposed extendedly along the edge of the masking piece 20 corresponding to the gap 13.

Still referring to FIG. 1A, FIG. 1B, and FIG. 4, the masking piece 20 shown in the drawings may solve the problem that the notebook computer 10 is subjected to interference resulting from electrostatic discharge. The notebook computer 10 has an access key 11 and a housing 12, wherein the access key 11 are used to perform a preset control signal, and as in the application of multimedia software of the notebook computer, the signal output/input portion 111 within the access key 11 is used for electrically connecting the access key 11 to the motherboard 30 (as shown in FIG. 1B) to transmit an electric signal. And a gap 13 exists between the access key 11 and the housing 12. When a user presses on the access key 11 with a finger, the electrostatic charges on the human body itself, on the access key 11, or those conducted through the gap 13 between the access key 11 and the housing 12 will be conducted into the interior of the notebook computer 10 through the access key 11 and the gap 13.

At this time, the outside electrostatic charges will be attracted by the masking piece 20 due to the conductive property of the masking piece 20, such that a number of electronic elements within the notebook computer 10 can be prevented from being directly damaged by the electrostatic charges. The masking piece 20 may prevent the electrostatic charges from entering into the notebook computer 10 via the access key 11 with a hole opened at the position of the access key 11 and wrapping the access key 11. Further, the masking area 24 is a space formed with the protrusion 23 disposed extendedly from the edge of the masking piece 20, and which projects relatively from the signal output/input portion 111, therefore, the signal output/input portion 111 may be located in the masking area 24, and thereby being shielded. After being attracted by the masking piece 20, the electrostatic charges are guided to the ground portion 22 by the masking piece 20, and then are conducted from the ground portion 22 to a ground circuit or the housing 12 of the notebook computer 10, and thereby are conducted out of the notebook computer 10.

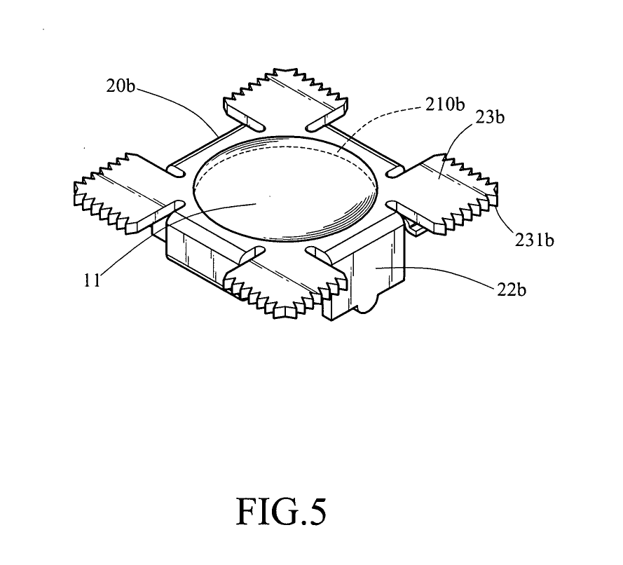

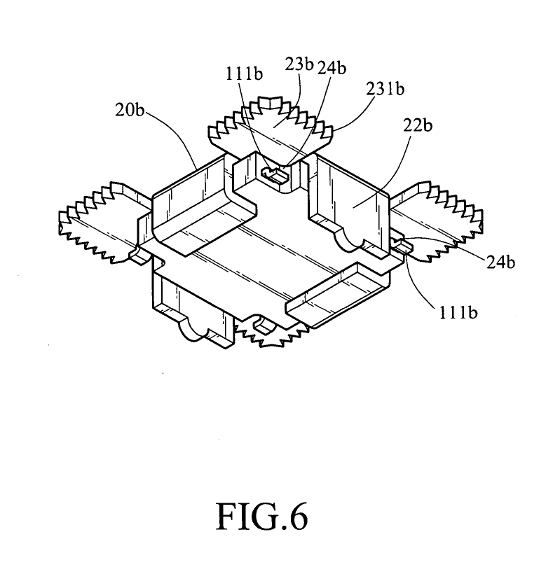

A second embodiment of the invention is shown in FIG. 1A, FIG. 5, and FIG. 6. A masking piece 20b is shown in the drawings, which comprises a ground portion 22b and a protrusion 23b, wherein the ground portion 22b is located approximately at the bottom of the access key 11, and the protrusion 23b is disposed corresponding to the position of the signal output/input portion 111 and having a plurality of successive zig-zag cuts 231b. A hole 210b is opened on the masking piece 20b, wherein the access key 11 is located in and wrapped by the hole 210b. The protrusion 23b is disposed extendedly along the edge of the masking piece 20b. A difference in height exists between the bottoms of the protrusion 23b and the masking piece 20b, therefore, a masking area 24b located above the signal output/input portion 111 is formed. The top surfaces of the masking piece 20b and the protrusion 23b are coplanar, and the ground portion 22b is disposed extendedly along the edge of the masking piece 20b corresponding to the gap 13.

Since the charges have the property of concentrating on the tip of a charge-carrying conductor, when the electrostatic charges get close to the conductor carrying charges, the tip of the conductor will be induced to carry charges of a different polarity, so as to attract the electrostatic charges. When more and more charges of different polarity are accumulated, a great deal of electrostatic charges is then attracted towards the tip. This theory is utilized in the zig-zag cuts 231b of the protrusion 23b in the masking piece 20b, and therefore the protrusion 23b may be used to capture the free electrostatic charges, and the zig-zag cuts 231b further acts as a lightning rod, After being captured by the zig-zag cuts 231b, the free electrostatic charges are guided from the zig-zag cuts 231b to the ground portion 22b and then are further conducted from the ground portion 22b to a ground circuit or the housing 12 of the notebook computer 10, and thereby are conducted out of the notebook computer 10.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A protective structure for electrostatic discharge, comprising:
at least one press element for performing a preset control signal and having a signal output/input portion electrically connected to a motherboard; and
a masking piece made of a conductive material and just wrapping the press element, which has a plurality of protrusions corresponding to the signal output/input portion, and a ground portion located at the bottom of the press element.

2. The protective structure for electrostatic discharge as claimed in claim 1, wherein successive zig-zag cuts are opened on the edge of the protrusions.

3. The protective structure for electrostatic discharge as claimed in claim 1, wherein the top surfaces of the masking piece and the protrusion are coplanar.

4. The protective structure for electrostatic discharge as claimed in claim 1, wherein a hole is opened on the masking piece, which is used for wrapping the press element.

5. The protective structure for electrostatic discharge as claimed in claim 1, wherein a difference in height exists between the bottoms of the protrusion and the masking piece to form a masking area.

6. The protective structure for electrostatic discharge as claimed in claim 5, wherein the signal output/input is located in the masking area.

7. The protective structure for electrostatic discharge as claimed in claim 1, wherein the press element is an access key.
